(19) United States
(12) Patent Application Publication
(10) Pub. No.: US 2021/0335526 A1
(43) Pub. Date: Oct. 28, 2021

(54) Composite particles, core, and electronic component

(71) Applicant: TDK CORPORATION, Tokyo (JP)

(72) Inventors: Yasuhide YAMASHITA, Tokyo (JP); Kotaro TERAO, Tokyo (JP); Shinsuke HASHIMOTO, Tokyo (JP)

(73) Assignee: TDK CORPORATION, Tokyo (JP)

(21) Appl. No.: 17/242,924

(22) Filed: Apr. 28, 2021

(30) Foreign Application Priority Data
Apr. 28, 2020 (JP) 2020-079622

(51) Int. Cl. H01F 1/34

(52) U.S. Cl. CPC H01F 1/344; H01F 27/255

(57) ABSTRACT

A core can be used for an electronic component, and composite particles constitute the core. The composite particles contain magnetic large particles, small particles directly or indirectly attached to surfaces of the large particles and have an average particle size smaller than an average particle size of the large particles, and a mutual buffer film covering at least part of the surfaces of the large particles located between the small particles existing around the large particles. When the average particle size of the large particles is R, the average particle size of the small particles is r, and an average thickness of the mutual buffer film is t, (r/R) is 0.0012 or more and 0.025 or less, (t/r) is larger than 0 and 0.7 or less, and r is 12 nm or more and 100 nm or less.

### BACKGROUND OF THE INVENTION

### Field of the Invention

The present invention relates to an electronic component such as an inductor element, and relates to a core used for the electronic component and composite particles constituting the core.

### Description of the Related Art

For an electronic component such as an inductor element, a core obtained by compression molding magnetic particles and a binder is used. In particular, coating with a thickness of approximately 10 nm to 100 nm is performed on surfaces of metal magnetic particles in order to impart a rust prevention property and an insulating property to the metal magnetic particles.

For example, in Patent Literature 1 (JP-A-2017-188678), a phosphate coating layer is formed on surfaces of Fe-based soft magnetic powder particles, and a silica-based insulating film is formed outside the phosphate coating layer.

A soft magnetic powder in Patent Literature 2 (JP-A-2009-10180) includes a powder main body part containing Fe and further containing Al, Si, or the like, a coating film of an oxide of Al, Si, or the like, and a coating film of an oxide of B.

However, there is a problem that the electronic component including the core manufactured by using the magnetic particles including the coating films in the related art has an insufficient DC superimposition characteristic and withstand voltage, and a remarkable decrease in withstand voltage in a high temperature environment.

### SUMMARY OF THE INVENTION

The present invention is made in view of the above circumstance and an object thereof is to provide an electronic component such as an inductor element that has a high DC superimposition characteristic and a high withstand voltage and prevents a decrease in withstand voltage in a high temperature environment, a core used for the electronic component, and composite particles that constitute the core.

In order to achieve the above object, composite particles according to the present invention contain magnetic large particles, small particles directly or indirectly attached to surfaces of the large particles and have an average particle size smaller than an average particle size of the large particles, and a mutual buffer film covering at least part of the surfaces of the large particles located between the small particles existing around the large particles.

When the average particle size of the large particles is R, the average particle size of the small particles is r, and an average thickness of the mutual buffer film is t,

(r/R) is 0.0012 or more and 0.025 or less,

(t/r) is larger than 0 and 0.7 or less, and

r is 12 nm or more and 100 nm or less.

The present inventor has found that with the above-mentioned configuration of the composite particles according to the present invention, an electronic component such as an inductor element including a core molded using the composite particles has a high DC superimposition characteristic, a high withstand voltage, and a high magnetic permeability, and prevents a decrease in withstand voltage in a high temperature environment.

It is considered that with the above-mentioned configuration of the composite particles of the present invention, the large particles are unlikely to come into contact with each other even when molded at a high pressure. This is because the small particles act as spacers between the large particles. As a result, a predetermined distance can be created between the large particles, and it is considered that a distance between the large particles can be set to a certain level or more. It is considered that when the distance between the large particles is set to a certain level or more, the large particles can be prevented from coming into contact with each other even when molded at a high pressure, a decrease in volume resistivity can be prevented, and the withstand voltage can be increased.

In addition, when the large particles are prevented from coming into contact with each other, it is possible to prevent magnetic field concentration, thereby preventing occurrence of magnetic saturation. Therefore, it is considered that the DC superimposition characteristic can be improved.

Further, it is considered that when the surfaces of the large particles are covered with the mutual buffer film, the small particles on the surfaces of the large particles can be prevented from moving along the surfaces of the large particles during molding. Therefore, certainty that the small particles function as the spacers between the large particles when molded at a high pressure is considered to increase. It is considered that the DC superposition characteristic is further improved since the magnetic field concentration is further prevented by covering the surfaces of the large particles with the mutual buffer film.

With the above-mentioned configuration, the composite particles of the present invention can be molded at a relatively high pressure. Therefore, the magnetic permeability can be increased.

Further, in the present invention, by keeping the average thickness of the mutual buffer film within a predetermined range, a high magnetic permeability can be ensured and a manufacturing cost can be reduced.

In the present invention, since the distance between the large particles can be set to a certain level or more by the small particles, it is possible to prevent the withstand voltage from decreasing in a high temperature environment.

In the composite particles according to the present invention, it is preferable that the small particles have a non-magnetic property and an insulating property.

In the composite particles according to the present invention, the small particles may be made of at least one selected from the group consisting of titanium oxide, aluminum oxide, magnesium oxide, zinc oxide, bismuth oxide, yttrium oxide, calcium oxide, silicon oxide, and ferrite.

In the composite particles according to the present invention, the small particles may be SiO₂ particles.

The SiO₂ particles have an advantage of being inexpensive. In addition, the SiO₂ particles have a lineup of particle sizes from several nm to several hundred nm. Further, the SiO₂ particles tend to have a narrow particle size distribution, and thus can be uniform spacers between particles.

In the composite particles according to the present invention, it is preferable that the mutual buffer film has a non-magnetic property and an insulating property.

In the composite particles according to the present invention, the mutual buffer film may be obtained by a sol-gel reaction of one of a metal alkoxide precursor and a non-metal alkoxide or a combination thereof.

In the composite particles according to the present invention, the mutual buffer film may be tetraethoxysilane (TEOS).

In the present invention, the withstand voltage can be further increased by using TEOS as the mutual buffer film. TEOS has an advantage of being low in material cost. In addition, by using TEOS as the mutual buffer film, a thickness of the mutual buffer film can be adjusted by temperature, time, or an amount of the TEOS charged.

A core according to the present invention has a cross section or a surface on which the above-mentioned composite particles are observed.

An electronic component according to the present invention includes the above-mentioned core.

### BRIEF DESCRIPTION OF THE DRAWINGS

FIG. 1 is a schematic cross-sectional view of composite particles according to an embodiment of the present invention.

FIG. 2 is a cross-sectional view of an inductor element according to the embodiment of the present invention.

FIG. 3 is a schematic cross-sectional view of a core according to the embodiment of the present invention.

### DETAILED DESCRIPTION OF THE PREFERRED EMBODIMENTS

### First Embodiment

<Composite Particles>

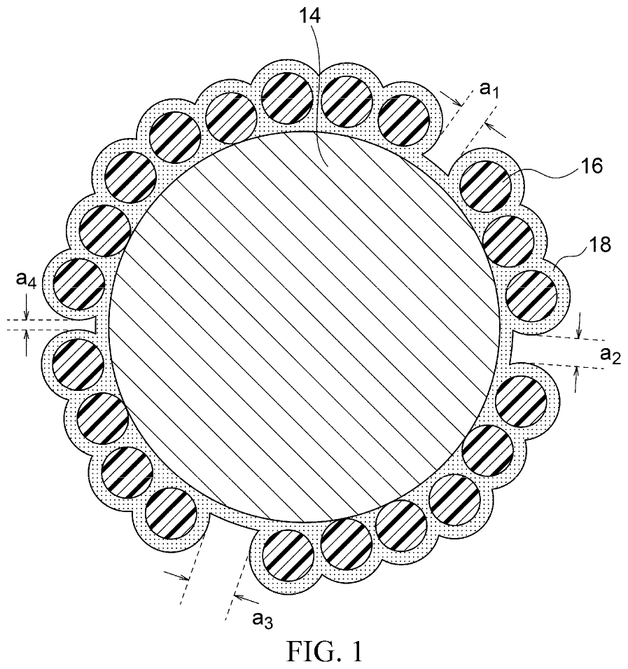

As shown in FIG. 1, in composite particles 12 according to the present embodiment, small particles 16 having an average particle size smaller than an average particle size of large particles 14 are directly or indirectly attached to surfaces of the large particles 14. That is, the small particles 16 may be directly attached to the surfaces of the large particles 14; the small particles 16 may be indirectly attached to the surfaces of the large particles 14 via a mutual buffer film 18 described later; or the small particles 16 may be attached to the surfaces of the large particles 14 via one or more other small particles 16.

In the present embodiment, the mutual buffer film 18 covers at least the surfaces of the large particles 14 located between the small particles 16 existing around the large particles 14. The mutual buffer film 18 may cover the surfaces of the large particles 14 located between the small particles 16 existing around the large particles 14, or may further cover surfaces of the small particles 16.

<Large Particles>

The large particles 14 in the present embodiment are magnetic. The large particles 14 in the present embodiment are preferably metal magnetic particles or ferrite particles, more preferably metal magnetic particles, and still more preferably contain Fe.

Specific examples of the metal magnetic particles containing Fe include particles of pure iron, carbonyl Fe, Fe-based alloys, Fe—Si-based alloys, Fe—Al-based alloys, Fe—Ni-based alloys, Fe—Si—Al-based alloys, Fe—Si—Cr-based alloys, Fe—Co-based alloys, Fe-based amorphous alloys, Fe-based nanocrystal alloys, and the like.

Examples of the ferrite particles include Ni—Cu-based ferrite particles and the like.

In the present embodiment, as the large particles 14, a plurality of large particles 14 made of the same material may be used, or a plurality of large particles 14 made of different materials may be mixed and used. For example, a plurality of Fe-based alloy particles as the large particles 14 and a plurality of Fe—Si-based alloy particles as the large particles 14 may be mixed and used.

The average particle size (R) of the large particles 14 in the present embodiment is preferably 400 nm or more and 100,000 nm or less, more preferably 3000 nm or more and 30,000 nm or less. The larger the average particle size (R) of the large particles 14, the higher the magnetic permeability tends to be.

When the large particles 14 are configured by two or more kinds of large particles 14 made of different materials, the average particle size of the large particles 14 made of one material and the average particle size of the large particles 14 made of another material may be different as long as the two average particle sizes are both within the above range.

Examples of the different materials include a case where elements constituting the metal or the alloy are different, a case where constituent elements are the same but compositions thereof are different, and the like.

<Small Particles>

The small particles 16 in the present embodiment are smaller than the large particles 14. In the present embodiment, when the average particle size of the large particles 14 is R and the average particle size of the small particles 16 attached to the large particles 14 is r, (r/R) is 0.0012 or more and 0.025 or less, and preferably 0.002 or more and 0.015 or less.

The average particle size (r) of the small particles 16 is 12 nm to 100 nm, and preferably 12 nm to 60 nm.

In a cross section of one composite particle 12, a length of a circumference of one large particle 14 is L, and as shown in FIG. 1, distances between two adjacent small particles 16 on the circumference of the large particle 14 are a1, a2, . . . . In this case, a coverage of the small particles 16 with respect to the large particle 14 is expressed as {L−(a1+a2 . . . )}/L. In the present embodiment, the coverage of the small particles 16 with respect to the large particle 14 is preferably 30% or more and 100% or less.

The number of the small particles 16 attached to the large particle 14 is not particularly limited. When the cross section of the composite particle 12 is observed in an approximately diameter portion of the large particle 14, it is preferable that 6 or more small particles 16 are observed, and more preferably 12 or more small particles 16 are observed.

In the present embodiment, a material of the small particles 16 is not particularly limited, but preferably has a non-magnetic property and an insulating property. The small particles 16 are more preferably particles made of a metal oxide, such as SiO₂ particles, TiO₂ particles, Al₂O₃ particles, SnO₂ particles, MgO particles, Bi₂O₃ particles, Y₂O₃ particles and/or CaO particles, or particles made of ferrite, and are still more preferably SiO₂ particles.

In the present embodiment, as the small particles 16, a plurality of small particles 16 made of the same material may be used, or a plurality of small particles 16 made of different materials may be mixed and used.

D90 of the small particles 16 of the present embodiment is preferably smaller than D10 of the large particles 14.

Here, D10 is a particle size of particles whose cumulative frequency is 10% counting from a small particle size side.

D90 is a particle size of particles whose cumulative frequency is 90% counting from the small particle size side.

The D10 of the large particles 14 can be measured by a particle size distribution measuring machine such as a laser diffraction type particle size distribution measuring machine HELOS (Japan Laser Corp.). The D90 of the small particles 16 can be measured by a wet particle size distribution measuring machine Zetasizer Nano ZS (Spectris Co., Ltd.) or the like.

When the small particles 16 are configured by two or more kinds of small particles 16 made of different materials, the average particle size of the small particles 16 made of one material and the average particle size of the small particles 16 made of another material may be different.

<Mutual Buffer Film>

In the present embodiment, the mutual buffer film 18 covers at least part of the surfaces of the large particles 14 located between the small particles 16 existing around the large particles 14.

In the present embodiment, when the average particle size of the small particles 16 is r and an average thickness of the mutual buffer film 18 is t, (t/r) is larger than 0 and 0.7 or less, and preferably 0.1 or more and 0.5 or less.

A material of the mutual buffer film 18 of the present embodiment is not particularly limited, but preferably has a non-magnetic property and an insulating property, and it is more preferable that the mutual buffer film 18 can impart a rust prevention property to the large particles 14. The mutual buffer film 18 of the present embodiment is preferably manufactured by a sol-gel method, and is preferably obtained by a sol-gel reaction of one of a metal alkoxide precursor and a non-metal alkoxide or a combination thereof.

Examples of the metal alkoxide precursor include aluminate, titanium acid, and zirconate. Examples of the non-metal alkoxide include alkoxysilanes, alkoxyborates, and the like, such as tetramethoxysilane (TMOS) and tetraethoxysilane (TEOS). Examples of an alkoxy group of the alkoxysilanes include an ethyl group, a methoxy group, a propoxy group, a butoxy group, or other long-chain hydrocarbon alkoxy groups.

Specific examples of the material of the mutual buffer film 18 of the present embodiment include TEOS, magnesium oxide, glass, resin, and phosphates such as zinc phosphate, calcium phosphate, and iron phosphate. The material of the mutual buffer film 18 of the present embodiment is preferably TEOS. Therefore, the withstand voltage can be further improved.

The average thickness (t) of the mutual buffer film 18 of the present embodiment is preferably larger than 0 nm and 70 nm or less, and more preferably 5 nm or more and 20 nm or less. The average thickness of the mutual buffer film 18 is preferably smaller than the average particle size of the small particles 16. The smaller the average thickness of the mutual buffer film 18, the higher the magnetic permeability tends to be, and the manufacturing cost can be reduced.

For example, when the mutual buffer film 18 is TEOS, the average thickness of the mutual buffer film 18 can be adjusted by changing a reaction time and a reaction temperature in a reaction between the large particles 14 and a mutual buffer film raw material solution described later, or by changing a concentration of TEOS in the mutual buffer film raw material solution.

<Inductor Element>

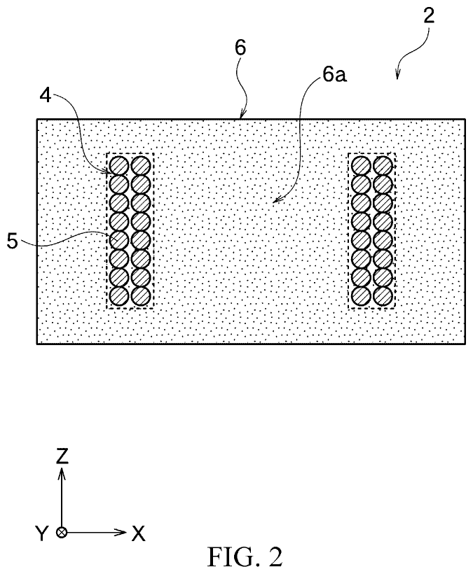

The composite particles 12 in the present embodiment can be used as particles constituting a core 6 of an inductor element 2 shown in FIG. 2, for example. As shown in FIG. 2, the inductor element 2 according to the embodiment of the present invention includes a winding portion 4 and the core 6. In the winding portion 4, a conductor 5 is wound in a coil shape. The core 6 is made of the particles and a binder.

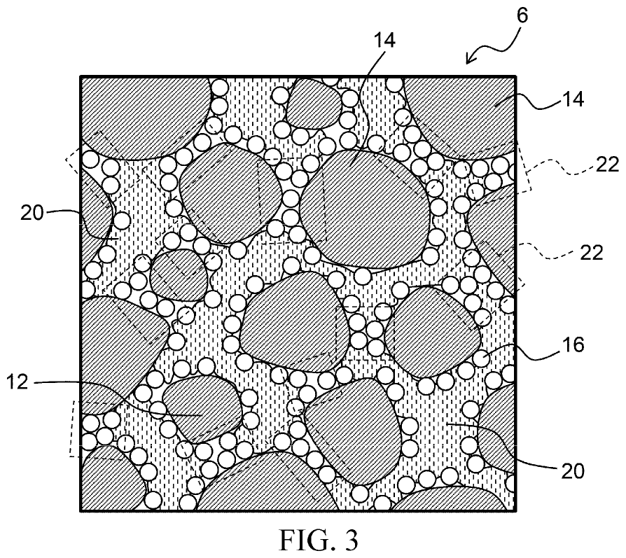

As shown in FIG. 3, the core 6 is molded by compressing, for example, the composite particles 12 and a binder 20. Such a core 6 is fixed in a predetermined shape by binding the large particles 14 to each other via the binder 20. In FIG. 3, the mutual buffer film 18 is not shown for simplification, but in the composite particles 12 of FIG. 3, the mutual buffer film 18 covers at least part of the surfaces of the large particles 14 located between the small particles 16 existing around the large particles 14.

In the present embodiment, at least a part of the core 6 (for example, a central portion 6a of the core 6) may be constituted by, for example, predetermined composite particles 12 shown in FIG. 1.

Preferably, when a total amount of the particles constituting at least a part of the core 6 (for example, the central portion 6a of the core 6), other particles, and the binder 20 is 100 mass %, the predetermined composite particles 12 shown in FIG. 1 is 10 mass % or more and 99.5 mass % or less.

Here, “other particles” mean particles other than the predetermined composite particles 12 and the binder 20, having a composition different from that of the predetermined composite particles 12, having no mutual buffer film 18 formed thereon, and the like. Examples of the other particles include particles of pure iron, carbonyl Fe, Fe-based alloys, Fe—Si-based alloys, Fe—Al-based alloys, Fe—Ni-based alloys, Fe—Si—Al-based alloys, Fe—Si—Cr-based alloys, Fe—Co-based alloys, Fe-based amorphous alloys, Fe-based nanocrystal alloys, and the like.

As a resin serving as the binder 20 constituting the core 6, a known resin can be used. Specific examples thereof include an epoxy resin, a phenol resin, a polyimide resin, a polyamideimide resin, a silicone resin, a melamine resin, a urea resin, a furan resin, an alkyd resin, an unsaturated polyester resin, a diallyl phthalate resin, and the like, and an epoxy resin is preferred. The resin serving as the binder 20 constituting the core 6 may be a thermosetting resin or a thermoplastic resin, and is preferably a thermosetting resin.

Since the composite particles 12 of the present embodiment have the above-described configuration, it is difficult for the large particles 14 to come into contact with each other even when molded at a high pressure. This is because, as shown in FIG. 3, one or more small particles 16 smaller than the large particles 14 exist as spacers between the large particles 14. Therefore, a predetermined distance can be created between the large particles 14, and the distance between the large particles 14 can be set to a certain level or more.

“One or more small particles 16 smaller than the large particles 14 exist as spacers between the large particles 14” means that one or more small particles 16 directly or indirectly attached to the surface of one of two adjacent large particles 14 and also directly or indirectly attached to the surface of the other large particle 14 exist. It may also mean that one or more small particles 16 directly or indirectly attached to the surface of one of the two adjacent large particles 14 and also directly or indirectly attached to the surface of the other large particle 14 via other small particles 16 exist.

For example, in FIG. 3, in spacer regions 22 surrounded by dotted lines, the small particles 16 having a particle size smaller than that of the large particles 14 exist as spacers between the large particles 14.

Furthermore, as shown in FIG. 1, since the surface of the large particle 14 is covered with the mutual buffer film 18, the small particles 16 on the surface of the large particle 14 can be prevented from moving along the surface of the large particle 14 during molding. Therefore, it is possible to increase certainty that the small particles 16 function as spacers between the large particles 14 when molded at a high pressure. The mutual buffer film 18 of the present embodiment preferably continuously covers the surfaces of the large particles 14 and the small particles 16, but does not necessarily have to be continuous.

As shown in FIG. 3, when the small particles 16 smaller than the large particles 14 exist as spacers between the large particles 14, a predetermined distance can be created between the large particles 14 and the distance between the large particles 14 can be set to be a certain level or more. Therefore, since the large particles 14 are unlikely to come into contact with each other even when molded at a high pressure, it is possible to prevent a plurality of large particles from forming an aggregate, the volume resistivity is increased, and the withstand voltage is increased.

By preventing the large particles from coming into contact with each other, it is possible to prevent magnetic field concentration, thereby preventing occurrence of magnetic saturation. Therefore, it is considered that the DC superimposition characteristic can be improved.

As described above, in the composite particles 12 of the present embodiment, since the small particles 16 and the mutual buffer film 18 attached to the surfaces of the large particles 14 are difficult to peel off, the magnetic field concentration and the occurrence of the magnetic saturation can be further prevented. Therefore, the core 6 using such composite particles 12 tends to have a higher DC superimposition characteristic.

Furthermore, by changing the average particle size of the small particles 16 attached to the surfaces of the large particles 14, the distance between the large particles 14 can be kept as intended and constant. Therefore, a desired DC superimposition characteristic, withstand voltage, and magnetic permeability can be obtained, and the DC superimposition characteristic, withstand voltage, and magnetic permeability as product characteristics can be stably adjusted.

The composite particles 12 of the present embodiment have the above-mentioned configuration, and thus can be molded at a relatively high pressure. Therefore, the magnetic permeability can be increased.

Further, by keeping the average thickness of the mutual buffer film 18 within a predetermined range, the magnetic permeability can be ensured to be high, and the manufacturing cost can be reduced.

In the present embodiment, since the distance between the large particles 14 is set to a certain level or more by the small particles 16, it is possible to prevent the withstand voltage from decreasing in a high temperature environment. For example, the inductor element 2 is required to have a heat resistant temperature of 150° C. or higher to be used for in-vehicle applications. In this regard, as described above, the inductor element 2 having the cross section or the surface on which the composite particles 12 of the present embodiment are observed can prevent a decrease in withstand voltage even in a high temperature environment. Therefore, the inductor element 2 can be suitably used for the in-vehicle applications requiring a heat resistant temperature of 150° C. or higher.

<Method of Manufacturing Composite Particles>

The large particles 14 and the small particles 16 are prepared, and the small particles 16 are attached to the surfaces of the large particles 14. A method for attaching the small particles 16 to the surfaces of the large particles 14 is not particularly limited. For example, the small particles 16 may be attached to the surfaces of the large particles 14 by electrostatic adsorption; the small particles 16 may be attached to the surfaces of the large particles 14 by a mechanochemical method; the small particles 16 may be attached to the surfaces of the large particles 14 by a method of precipitating the small particles 16 on the surfaces of the large particles 14 by synthesis; and the small particles 16 may be attached to the large particles 14 via an organic material such as a resin.

In the present embodiment, it is preferable to attach the small particles 16 to the surfaces of the large particles 14 by electrostatic adsorption. This is because, in a case of electrostatic adsorption, it is possible to attach the small particles 16 to the surfaces of the large particles 14 with low energy. Compared with the mechanochemical method, the electrostatic adsorption can attach the small particles 16 to the surfaces of the large particles 14 with low energy, so that distortion of the particles is less likely to occur, and the core loss can be reduced. In the electrostatic adsorption, the large particles 14 and the small particles 16 are charged with opposite charges and then adsorbed, so that there is an advantage that it is easy to control an amount of the small particles 16 attached to the large particles 14.

Next, the mutual buffer film 18 is formed on the large particles 14 to which the small particles 16 are attached. A method for forming the mutual buffer film 18 is not particularly limited. For example, the large particles 14 to which the small particles 16 are attached are immersed in a solution in which a compound or a precursor thereof that constitutes the mutual buffer film 18 is dissolved. Alternatively, the solution is sprayed onto the large particles 14 to which the small particles 16 are attached. Next, a heat treatment and the like are performed on the large particles 14 and the small particles 16 to which the solution is attached. Therefore, the mutual buffer film 18 can be formed on the large particles 14 and the small particles 16.

Specifically, the mutual buffer film 18 can be formed on the large particles 14 and the small particles 16 by the following method. First, the large particles 14 to which the small particles 16 are attached and the mutual buffer film raw material solution are mixed.

Here, the mutual buffer film raw material solution is a solution containing components constituting the mutual buffer film 18. In the present embodiment, for example, when the mutual buffer film 18 is TEOS, a solution containing TEOS, water, ethanol, and hydrochloric acid can be used as the mutual buffer film raw material solution.

A mixed solution of the large particles 14 to which the small particles 16 are attached and the mutual buffer film raw material solution is heated in a sealed pressure vessel, and a wet gel of TEOS is obtained by the sol-gel reaction. A heating temperature is not particularly limited, and is, for example, 20° C. to 80° C. A heating time is also not particularly limited, and is 5 hours to 10 hours. The wet gel of TEOS is further heated at 65° C. to 75° C. for 5 hours to 24 hours to obtain a dry gel, that is, the composite particles 12.

<Method of Manufacturing Core>

In the present embodiment, the core 6 is manufactured using the above-mentioned composite particles 12.

As shown in FIG. 2, the above-mentioned composite particles 12 and an air-cored coil formed by winding the conductor (wire) 5 a predetermined number of times are filled into a mold and compression-molded to obtain an element body in which the coil is embedded therein. A compression method is not particularly limited, and the compression may be performed from one direction, or may be isotropically performed by warm isostatic press (WIP), cold isostatic press (CIP), or the like, but is preferably isotropically performed. Therefore, rearrangement and densification of an internal structure of the large particles 14 and the small particles 16 can be achieved.

By heat-treating the obtained element body, the large particles 14 and the small particles 16 are fixed, and the core 6 having a predetermined shape in which the coil is embedded can be obtained. Such a core 6 functions as a coil-type electronic component such as the inductor element 2 since the coil is embedded therein.

### Second Embodiment

The present embodiment is the same as the composite particles 12 of the first embodiment except for that as shown below. Although not shown, in the present embodiment, a coating layer is included on at least a part of the surface of the large particles 14. In the present embodiment, the large particles 14 can be prevented from oxidation by including the coating layer in a process of manufacturing the core 6 shown in FIG. 2. By including the coating layer, a non-magnetic and insulating layer can be imparted onto the surface of the large particles 14, and therefore, magnetic characteristics (the DC superimposition characteristic and the withstand voltage) can be improved.

A material of the coating layer is not particularly limited, and examples thereof include TEOS, magnesium oxide, glass, resin, and phosphates such as zinc phosphate, calcium phosphate, and iron phosphate. The material of the coating layer is preferably TEOS. Therefore, the withstand voltage can be maintained higher.

The coating layer covering the surface of the large particles 14 may cover at least part of the surfaces of the large particles 14, but preferably covers the entire surface. Furthermore, the coating layer may continuously or intermittently cover the surface of the large particles 14.

Not all the large particles 14 include the coating layer. For example, 50% or more of the large particles 14 may include the coating layer.

When the large particles 14 include the coating layer as in the present embodiment, a value described as the average particle size (R) of the large particles 14 in the first embodiment is understood as including the coating layer in the particle size of the large particles 14.

Similarly, when the large particles 14 include the coating layer as in the present embodiment, the content described as D10 of the large particles 14 in the first embodiment is understood as including the coating layer in the particle size of the large particles 14.

A method for forming the coating layer on the surface of the large particles 14 is not particularly limited, and a known method can be adopted. For example, the coating layer can be formed by performing a wet treatment on the large particles 14.

Specifically, the large particles 14 are immersed in a solution in which a compound or a precursor thereof constituting the coating layer is dissolved, or the solution is sprayed onto the large particles 14. Next, a heat treatment and the like are performed on the large particles 14 to which the solution is attached. Therefore, the coating layer can be formed on the large particles 14.

Since the composite particles 12 of the present embodiment have the above-described configuration, even if the coating layer is peeled off or the coating layer is cracked due to the large particles coming into contact with each other and being compressed and deformed, it is difficult for the large particles 14 to come into contact with each other. This is because, as shown in FIG. 3, the small particles 16 smaller than the large particles 14 exist as spacers between the large particles 14. Therefore, a predetermined distance can be created between the large particles 14, and the distance between the large particles 14 can be set to a certain level or more.

In this way, peeling and cracking of the insulating coating layer can be prevented. Therefore, it is possible to prevent the volume resistivity from decreasing and to improve the withstand voltage.

The coating layer functions as a non-magnetic layer to improve the DC superimposition characteristic. In the present embodiment, since the peeling and cracking of the coating layer can be prevented, the DC superimposition characteristic tends to be higher.

In the present embodiment, even if the peeling or cracking occur in the coating layer in a high temperature environment due to a difference in a linear expansion coefficient between the large particles 14 and the coating layer, since the distance between the large particles 14 can be set to a certain level or more by the small particles 16, it is possible to prevent a decrease in withstand voltage.

### Third Embodiment

The present embodiment is the same as the first embodiment except for that as shown below. That is, in the first embodiment, TEOS is used as the mutual buffer film 18, but in the present embodiment, the mutual buffer film 18 is made of a resin. A method for forming the mutual buffer film in the present embodiment is not particularly limited. An example of the method for forming the mutual buffer film in the present embodiment is as follows.

The large particles 14 to which the small particles 16 are attached and a resin-soluble solution in which the resin is dissolved are mixed to generate a first solution.

Next, a resin-insoluble solution is added to the first solution to generate a second solution. Here, the resin-insoluble solution is a solution that is insoluble in the resin dissolved in the previous step but is soluble in the resin-soluble solution.

By adding the resin-insoluble solution to the first solution to generate the second solution, the resin-soluble solution dissolves in the resin-insoluble solution. Therefore, the resin dissolved in the resin-soluble solution can be precipitated as the mutual buffer film 18.

The second solution is then dried. Accordingly, the precipitated mutual buffer film 18 (resin) is attached to the surfaces of the large particles 14, and the composite particles 12 in which the mutual buffer film 18 (resin) is attached to the surfaces of the large particles 14 can be obtained.

Although the embodiments of the present invention have been described above, the present invention is not limited to the above embodiments, and may be modified in various ways within a scope of the present invention.

For example, as the inductor element 2, a configuration in which the air-cored coil around which the conductor 5 is wound is embedded inside the core 6 having a predetermined shape as shown in FIG. 2 is shown above. However, a structure thereof is not particularly limited, and any structure may be used as long as the conductor is wound around the surface of the core having a predetermined shape.

Examples of the shape of the core include FT type, ET type, EI type, UU type, EE type, EER type, UI type, drum type, toroidal type, pot type, cup type, and the like.

Although the composite particles 12 used for the core 6 have been described above, uses of the composite particles 12 of the present invention are not limited to the core 6, and can be used for other electronic components containing particles. For example, the composite particles 12 can be used for electronic components formed by using a dielectric paste or an electrode paste, a magnet containing a magnetic powder, a lithium ion battery and an all-solid-state lithium battery, or a magnetic shield sheet.

When the composite particles 12 of the present embodiment are used as dielectric particles of the dielectric paste, examples of the material of the large particles 14 include barium titanate, calcium titanate, strontium titanate, and the like, and examples of the material of the small particles 16 include silicon, rare earth elements, alkaline earth metals, and the like.

When the composite particles 12 of the present embodiment are used as electrode particles of the electrode paste, examples of the material of the large particles 14 include Ni, Cu, Ag or Au, alloys thereof, carbon, and the like.

### EXAMPLES

Hereinafter, the present invention will be described in more detail with reference to Examples, but the present invention is not limited to these Examples.

### Example 1

The large particles 14 on which the small particles 16 were attached to the surfaces were prepared by the electrostatic adsorption.

The material of the large particles 14 was Fe, and the average particle size thereof was 4000 nm.

The material of the small particles 16 was SiO₂, and the average particle size thereof was as shown in Table 1.

Next, a mutual buffer film raw material solution containing TEOS, water, ethanol, and hydrochloric acid was prepared and mixed with the large particles 14 to which the small particles 16 were attached.

Here, the average thickness of the mutual buffer film 18 was adjusted such that the ratio (t/r) of the average thickness t of the mutual buffer film to the average particle size r of the small particles 16 was as shown in Table 1. Specifically, the average thickness of the mutual buffer film 18 was adjusted by adjusting an amount of the mutual buffer film raw material solution added, and the heating temperature and the heating time described later.

The mixed solution of the large particles 14 to which the small particles 16 were attached and the mutual buffer film raw material solution was heated in a sealed pressure vessel to obtain a wet gel of TEOS. The heating temperature was 50° C. and the heating time was 8 hours. The wet gel of TEOS was further heated at approximately 100° C. for 1 week to obtain the composite particles 12.

The epoxy resin was weighed so that a solid content of the epoxy resin was 3 parts by mass with respect to 100 parts by mass of the composite particles 12 thus obtained, and then the composite particles 12 and the epoxy resin were mixed and stirred to generate particles.

The obtained particles were filled into a mold having a predetermined toroidal shape and pressed at a molding pressure of 6 t/cm² to obtain a element body of a core. The obtained element body of the core was heat-cured in the atmosphere at 200° C. for 4 hours to obtain a toroidal core (outer diameter: 17 mm, inner diameter: 10 mm).

Samples were prepared by winding a copper wire around the toroidal core with 32 turns.

A direct current was applied from 0 to each of the obtained samples. A value (ampere) of the current that flows in the sample when an inductance (pH) at 0 current drops to 80% was set to Idc1, and the sample was evaluated based on the numerical value of Idc1. When Idc1 was 30.0 A or more, the sample was evaluated as “A”. When Idc1 was 20.0 A or more and less than 30.0 A, the sample was evaluated as “B”. When Idc1 was less than 20.0 A, the sample was evaluated as “C”. Results are shown in Table 2.

A voltage was applied between terminal electrodes of each of the obtained samples using a DC POWER SUPPLY manufactured by the KEYSIGHT and an LCR meter, and a voltage under a current of 0.5 mA was used as a withstand voltage. When the withstand voltage exceeds 2.0 kV, the sample was evaluated as “A”. When the withstand voltage was 1 kV or more and less than 2.0 kV, the sample was evaluated as “B”. When the withstand voltage was less than 1 kV, the sample was evaluated as “C”. Results are shown in Table 2.

The magnetic permeability of the obtained samples was measured with an LCR meter (LCR428A manufactured by the HP). When the magnetic permeability was 25 or more, the sample was evaluated as “A”. When the magnetic permeability was 20 or more and less than 25, the sample was evaluated as “B”. When the magnetic permeability was less than 20, the sample was evaluated as “C”. Results are shown in Table 2.

The obtained samples were cut. A core 6 part of a cross section was observed with a scanning transmission electron microscope (STEM), and the average thickness (t) of the mutual buffer film 18 was measured and found to be 30 nm. An average coverage of the small particles 16 with respect to the large particles 14 in the same cross section was 50%.

TABLE 1

| | Composite particles | | | | |
|---|---|---|---|---|---|
| | Average | Average | Average | | |
| | particle size | particle size | thickness | | |
| | (R) [nm] | (r) [nm] | (t) [nm] | | |
| Sample | of large | of small | of mutual | | |
| No. | particles | particles | buffer film | r/R | t/r |
| 1 | 4000 | 300 | 8 | 0.075 | 0.027 |
| 2 | 4000 | 200 | 8 | 0.050 | 0.040 |
| 3 | 4000 | 100 | 8 | 0.025 | 0.080 |
| 4 | 4000 | 60 | 8 | 0.015 | 0.133 |
| 5 | 4000 | 45 | 8 | 0.011 | 0.178 |
| 6 | 4000 | 22 | 8 | 0.006 | 0.364 |
| 7 | 4000 | 12 | 8 | 0.003 | 0.667 |
| 8 | 4000 | 9 | 8 | 0.002 | 0.889 |

TABLE 2

| | Core | | | | | |
|---|---|---|---|---|---|---|
| Sample | DC superimposition | | Withstand | | Magnetic | |
| No. | characteristic (Idc1) [A] | | voltage [kV] | | permeability (μ) | |
| 1 | 34.0 | A | >2 | A | 18 | C |
| 2 | 32.0 | A | >2 | A | 19 | C |
| 3 | 30.0 | A | >2 | A | 20 | B |
| 4 | 28.0 | B | 1.8 | B | 21 | B |
| 5 | 26.0 | B | 1.75 | B | 22.5 | B |
| 6 | 25.0 | B | 1.6 | B | 24 | B |
| 7 | 24.0 | B | 1.4 | B | 26 | A |
| 8 | 23.0 | B | 0.7 | C | 28 | A |

### Example 2

Samples were prepared in the same manner as in Example 1 except that the average particle size of the large particles 14 was 10000 nm and the average particle size of the small particles 16 was as shown in Table 3, and the DC superimposition characteristic, withstand voltage, and magnetic permeability were measured in the same manner as in Example 1. Results are shown in Table 4.

TABLE 3

| | Composite particles | | | | |
|---|---|---|---|---|---|
| | Average | Average | Average | | |
| | particle size | particle size | thickness | | |
| | (R) [nm] | (r) [nm] | (t) [nm] | | |
| Sample | of large | of small | of mutual | | |
| No. | particles | particles | buffer film | r/R | t/r |
| 11 | 10000 | 300 | 8 | 0.0300 | 0.027 |
| 13 | 10000 | 60 | 8 | 0.0060 | 0.133 |
| 14 | 10000 | 45 | 8 | 0.0045 | 0.178 |
| 15 | 10000 | 22 | 8 | 0.0022 | 0.364 |
| 16 | 10000 | 12 | 8 | 0.0012 | 0.667 |
| 17 | 10000 | 9 | 8 | 0.0009 | 0.889 |

TABLE 4

| | Core | | | | | |
|---|---|---|---|---|---|---|
| Sample | DC superimposition | | Withstand | | Magnetic | |
| No. | characteristic (Idc1) [A] | | voltage [kV] | | permeability (μ) | |
| 11 | 32.4 | A | >2 | A | 17 | C |
| 13 | 23.4 | B | >2 | A | 23 | B |
| 14 | 22 | B | 1.6 | B | 25 | A |
| 15 | 20.5 | B | 1.35 | B | 26.8 | A |
| 16 | 20.1 | B | 1.1 | B | 28 | A |
| 17 | 19 | C | 0.75 | C | 30 | A |

From Tables 1 to 4, it was confirmed that the magnetic permeability under a case where (r/R) was 0.0012 or more and 0.025 or less, (t/r) was larger than 0 and 0.7 or less, and r was 12 nm or more and 100 nm or less (Sample Nos. 3 to 7 and 13 to 16) was better than that under a case where r was 200 nm or more and (r/R) was 0.030 or more (Sample Nos. 1, 2, and 11).

From Tables 1 to 4, it was confirmed that the withstand voltage under the case where (r/R) was 0.0012 or more and 0.025 or less, (t/r) was larger than 0 and 0.7 or less, and r was 12 nm or more and 100 nm or less (Sample Nos. 3 to 7 and 13 to 16) was better than that under a case where r was 9 nm or less and (t/r) was 0.889 or more (Sample Nos. 8 and 17).

### Example 3

The average particle size (R) of the large particles 14 was set to 4000 nm, and the average particle size (r) of the small particles 16 and the average thickness (t) of the mutual buffer film 18 were changed as shown in Tables 5 and 7. The average thickness of the mutual buffer film 18 was adjusted by changing a reaction time of the mutual buffer film raw material solution with the large particles 14. Other than that, samples were prepared in the same manner as in Example 1. With respect to the obtained samples, the average thickness of the mutual buffer film 18 and the magnetic permeability were measured in the same manner as in Example 1.

Furthermore, with respect to the obtained samples, a withstand voltage before heating (at a room temperature atmosphere) and a withstand voltage after heating (at an atmosphere temperature of 175° C.) were measured in the same manner as in Example 1. The withstand voltage after heating was measured by leaving the sample at 175° C. for 48 hours or longer, returning the temperature of the sample to the room temperature, and then measuring the withstand voltage in the room temperature atmosphere. In the present invention, when the withstand voltage before heating was 2.0 kV or more and the withstand voltage after heating was 1 kV or more, the sample was evaluated as “A”. When the withstand voltage before heating was 1.8 kV or more and less than 2.0 kV and the withstand voltage after heating was 1 kV or more, the sample was evaluated as “B”. When the withstand voltage after heating was less than 1 kV, the sample was evaluated as “C”. Results are shown in Tables 6 and 8.

TABLE 5

| | Composite particles | | | | |
|---|---|---|---|---|---|
| | Average | Average | Average | | |
| | particle size | particle size | thickness | | |
| | (R) [nm] | (r) [nm] | (t) [nm] | | |
| Sample | of large | of small | of mutual | | |
| No. | particles | particles | buffer film | r/R | t/r |
| 21 | 4000 | 200 | 5 | 0.0500 | 0.025 |
| 22 | 4000 | 100 | 5 | 0.0250 | 0.050 |
| 23 | 4000 | 60 | 5 | 0.0150 | 0.083 |
| 24 | 4000 | 45 | 5 | 0.0113 | 0.111 |
| 25 | 4000 | 22 | 5 | 0.0055 | 0.227 |
| 26 | 4000 | 12 | 5 | 0.0030 | 0.417 |
| 27 | 4000 | 9 | 5 | 0.0023 | 0.556 |
| 28 | 4000 | 5 | 5 | 0.0013 | 1.000 |
| 29 | 4000 | 0 | 5 | 0.0000 | |
| 30 | 4000 | 0 | 10 | 0.0000 | |
| 31 | 4000 | 0 | 15 | 0.0000 | |
| 32 | 4000 | 0 | 30 | 0.0000 | |
| 33 | 4000 | 0 | 40 | 0.0000 | |
| 34 | 4000 | 0 | 50 | 0.0000 | |
| 35 | 4000 | 0 | 100 | 0.0000 | |

TABLE 6

| | Core | | | | |
|---|---|---|---|---|---|
| | | | Withstand voltage | | |
| Sample | Magnetic | | | Before heating | After heating |
| No. | permeability (μ) | | Evaluation | [kV] | [kV] |
| 21 | C | 18 | A | 2.35 | 2.2 |
| 22 | B | 20 | A | 2.3 | 2.1 |
| 23 | A | 28 | A | 2.2 | 1.85 |
| 24 | A | 29 | A | 2.13 | 1.8 |
| 25 | A | 30 | B | 2.11 | 1.7 |
| 26 | A | 32 | B | 2.1 | 1.5 |
| 27 | A | 34 | C | 2 | 0.9 |
| 28 | A | 35 | C | 1.5 | 0.7 |
| 29 | A | 40 | C | 1.1 | 0.4 |
| 30 | A | 36 | C | 1.6 | 0.5 |
| 31 | A | 33 | C | 2.1 | 0.6 |
| 32 | A | 30 | C | 2.3 | 0.65 |
| 33 | B | 24 | C | 2.5 | 0.7 |
| 34 | C | 17 | C | 2.7 | 0.75 |
| 35 | C | 15 | C | 3 | 0.78 |

TABLE 7

| | Composite particles | | | | |
|---|---|---|---|---|---|
| | Average | Average | Average | | |
| | particle size | particle size | thickness | | |
| | (R) [nm] | (r) [nm] | (t) [nm] | | |
| Sample | of large | of small | of mutual | | |
| No. | particles | particles | buffer film | r/R | t/r |
| 41 | 4000 | 60 | 50 | 0.015 | 0.83 |
| 42 | 4000 | 60 | 40 | 0.015 | 0.67 |
| 43 | 4000 | 60 | 30 | 0.015 | 0.50 |
| 44 | 4000 | 60 | 25 | 0.015 | 0.42 |
| 45 | 4000 | 60 | 15 | 0.015 | 0.25 |
| 46 | 4000 | 60 | 10 | 0.015 | 0.17 |
| 47 | 4000 | 60 | 5 | 0.015 | 0.08 |
| 48 | 4000 | 60 | 3 | 0.015 | 0.05 |
| 49 | 4000 | 60 | 1 | 0.015 | 0.02 |
| 50 | 4000 | 60 | 0 | 0.015 | 0.00 |

TABLE 8

| | Core | | | | |
|---|---|---|---|---|---|
| | | | Withstand voltage | | |
| Sample | Magnetic | | | Before heating | After heating |
| No. | permeability (μ) | | Evaluation | [kV] | [kV] |
| 41 | C | 16 | A | 2.5 | 2.1 |
| 42 | B | 20 | A | 2.5 | 2.05 |
| 43 | B | 21 | A | 2.45 | 2 |
| 44 | B | 23 | A | 2.4 | 1.95 |
| 45 | B | 23 | A | 2.3 | 1.93 |
| 46 | B | 25 | A | 2.25 | 1.92 |
| 47 | B | 28 | A | 2.05 | 1.85 |
| 48 | A | 35 | A | 2 | 1.8 |
| 49 | A | 37 | B | 1.8 | 1 |
| 50 | A | 40 | C | 1.5 | 0.6 |

From Tables 5 to 8, it was confirmed that the magnetic permeability under the case where (r/R) was 0.0012 or more and 0.025 or less, (t/r) was larger than 0 and 0.7 or less, and r was 12 nm or more and 100 nm or less (Sample Nos. 22 to 26 and 42 to 49) was better than those under a case where r was 200 nm (Sample No. 21) and a case where (t/r) was 0.83 (Sample No. 41).

From Tables 5 to 8, it was confirmed that a decrease in withstand voltage in a high temperature environment was prevented better under the case where (r/R) was 0.0012 or more and 0.025 or less, (t/r) was larger than 0 and 0.7 or less, and r was 12 nm or more and 100 nm or less (Sample Nos. 22 to 26 and 42 to 49) than under a case where r was 9 nm or less (Sample Nos. 27 to 35) and a case where (t/r) was 0 (Sample No. 50).

### REFERENCE SIGNS LIST

2 inductor element
4 winding portion
5 conductor
6 core
6a central portion of core
12 composite particle
14 large particle
16 small particle
18 mutual buffer film
20 resin
22 spacer region

What is claimed is:

1. Composite particles, comprising:
magnetic large particles;
small particles directly or indirectly attached to surfaces of the large particles and have an average particle size smaller than an average particle size of the large particles; and
a mutual buffer film covering at least part of the surfaces of the large particles located between the small particles existing around the large particles, wherein
(r/R) is 0.0012 or more and 0.025 or less,
(t/r) is larger than 0 and 0.7 or less, and
r is 12 nm or more and 100 nm or less,
when the average particle size of the large particles is R, the average particle size of the small particles is r, and an average thickness of the mutual buffer film is t.

2. The composite particles according to claim 1, wherein
the small particles have a non-magnetic property and an insulating property.

3. The composite particles according to claim 1, wherein
the small particles comprise at least one selected from the group consisting of titanium oxide, aluminum oxide, magnesium oxide, zinc oxide, bismuth oxide, yttrium oxide, calcium oxide, silicon oxide, and ferrite.

4. The composite particles according to claim 1, wherein
the small particles comprise SiO₂ particles.

5. The composite particles according to claim 1, wherein
the mutual buffer film is obtained by a sol-gel reaction of one of a metal alkoxide precursor and a non-metal alkoxide or a combination thereof.

6. The composite particles according to claim 1, wherein
the mutual buffer film has a non-magnetic property and an insulating property.

7. The composite particles according to claim 1, wherein
the mutual buffer film comprises tetraethoxysilane.

8. The composite particles according to claim 4, wherein
the mutual buffer film comprises tetraethoxysilane.

9. A core comprising
the composite particles according to claim 1, when the composite particles are observed on a cross section or a surface of the core.

10. A core comprising
the composite particles according to claim 7, when the composite particles are observed on a cross section or a surface of the core.

11. An electronic component comprising
the core according to claim 9.

12. An electronic component comprising
the core according to claim 10.
